(19) United States
(12) Patent Application Publication
(10) Pub. No.: US 2024/0066370 A1
(43) Pub. Date: Feb. 29, 2024

(54) Glow in the Dark Golf Club Grip

(71) Applicant: T.K. International Corp., Honolulu, HI (US)

(72) Inventor: Toru Kamatari, Carlsbad, CA (US)

(21) Appl. No.: 18/241,119

(22) Filed: Aug. 31, 2023

Related U.S. Application Data
(60) Provisional application No. 63/402,591, filed on Aug. 31, 2022.

(51) Int. Cl. A63B 53/14; A63B 60/08

(52) U.S. Cl. CPC A63B 53/14; A63B 60/08

(57) ABSTRACT

A golf club grip that glows in the dark can make a golf club visible in the dark. A golf club is provided comprising a club shaft having an upper end and a lower end, a club head on a lower end of the shaft, and a grip on an upper end of the shaft, wherein the grip material includes phosphorescent pigments having the property of luminescence. A golf club grip is provided comprising a tube shape having an opening on one end, that a shaft of a golf club is inserted into, wherein the grip material includes phosphorescent pigments having the property of luminescence.

### CROSS REFERENCE TO RELATED APPLICATIONS

This application claims priority from U.S. provisional application 63/402,591 having a filing date of Aug. 31, 2022

### FIELD OF THE INVENTION

Embodiments of the invention generally relate to sports equipment. Specifically, embodiments of the invention relate to a golf club having a glow in the dark grip.

### BACKGROUND OF THE INVENTION

Golf is one of the most widely played sports in the world, and continues to increase in popularity. Often played on courses spanning several acres and taking several hours to play, there is a limited amount of availability to play golf during the day. Courses often have golfers playing twilight rounds up until the last moments of daylight and visibility. Alternatively, golfing at night has become popular on courses using glow in the dark golf balls. To further satisfy the demand for more golf, indoor driving ranges and simulators have grown in popularity as well. For all the foregoing reasons, a need exists for a golf club having a glow in the dark grip.

### SUMMARY

A golf club grip that glows in the dark can make a golf club visible in the dark. This invention improves safety, prevents lost clubs, can be a teaching aid, and provides overall improved enjoyment in the dark. Phosphorescence is the phenomenon of radiative emission by materials/substances as a result of the absorption of energy through ultraviolet rays and the subsequent re-emission in the form of visible light over a period time afterwards. Phosphorescent materials include phosphorescent pigments which have been artificially prepared and have the property of luminescence when activated by appropriate wavelengths of light.

A golf club is provided comprising a club shaft having an upper end and a lower end, a club head on a lower end of the shaft, and a grip on an upper end of the shaft, wherein the grip material includes phosphorescent pigments having the property of luminescence. A golf club grip is provided comprising a tube shape having an opening on one end, that a shaft of a golf club is inserted into, wherein the grip material includes phosphorescent pigments having the property of luminescence.

### BRIEF DESCRIPTION OF THE DRAWINGS

The accompanying drawings taken in conjunction with the detailed description will assist in making the advantages and aspects of the disclosure more apparent.

FIG. 1 is a drawing of a golf club.

FIG. 2 is a drawing of the textured material used for the golf club grip.

FIG. 3 is an image of glow in the dark golf club grips.

FIG. 4 is a chart of the phosphorescent pigment characteristics and results.

### DETAILED DESCRIPTION

Reference will now be made in detail to the present embodiments discussed herein, illustrated in the accompanying drawings. The embodiments are described below to explain the disclosed invention by referring to the Figures using like numerals. It will nevertheless be understood that no limitation of the scope is thereby intended, such alterations and further modifications in the illustrated invention, and such further applications of the principles as illustrated therein being contemplated as would normally occur to one skilled in the art to which the embodiments relate.

A golf club grip that glows in the dark and a golf club having a grip that glows in the dark are provided. The method of creating a golf club grip that glows in the dark and a golf club having a grip that glows in the dark are provided. A grip is an essential part of the golf club where a golfer holds on the (often made of metal) golf club. Golf clubs come in many different forms and makes, including but not limited to woods, irons, wedges, utility, and putters. The teachings of this invention are applicable to all such golf club types having grips, and no limitation is intended.

The primary benefit of the invention is to make a golf club visible in the dark. This allows for visibility of the golf club at the end of twilight golf rounds as night falls and during entire rounds played at night. During night rounds of golf, courses uses glow in the dark balls. Therefore, it would provide additional benefit to use glow in the dark clubs, which would be visible to players at night. Players often set their clubs down on the grass around the green or at other times, and having a glow in the dark club would reduce the chance of lost clubs. Additionally, a glow in the dark club in the hands of a golfer would help other golfers to recognize the presence of the golfer in the dark, to avoid hitting a golf ball at the golfer, providing a significant safety benefit on a golf course at night.

A glow in the dark golf club could also be used at indoor driving ranges and simulation locations, or other primarily night time social and party atmosphere often with low amounts of lighting, similar to Top Golf®. The glow in the dark feature of the disclosed invention adds to the atmosphere and fun of such golf venues.

A glow in the dark golf club grip can also serve as a teaching aid, to make sure that a golfer is gripping the club properly. As a golfer grips the club, visibility of the club through a golfer's fingers can reveal whether the golfer is gripping the club correctly. The ability to see the grip through the golfer's fingers is significantly improved with a glow in the dark grip.

Phosphorescence is the phenomenon of radiative emission by materials/substances as a result of the absorption of energy through ultraviolet rays and the subsequent re-emission in the form of visible light over a period time afterwards. Phosphorescent materials have been used in a variety of commercial applications because they have the property of continuing to emit light for an extended period of time after excitation. Thus, even when there is no light source, the materials continue glow in the dark. Phosphorescent materials include phosphorescent pigments which have been artificially prepared and have the property of luminescence when activated by appropriate wavelengths of light.

In the preferred embodiment, the golf grip is made primarily from a thermoplastic elastomer, though other rubber like or plastic like materials may be contemplated. Thermoplastic elastomers have the advantage of both plastic and rubber, having the strength and hardness of plastic while still maintaining some of the elasticity of rubber. Phosphorescent pigments can be incorporated into the thermoplastic elastomer during manufacturing which give the thermoplastic elastomer the glow in the dark characteristics. By incorporating the phosphorescent pigments throughout, wear on the grip will not affect the ability of the club to glow in the dark. Alternatively, a transparent cover may be utilized to surround the glow in the dark elements, such that the glow in the dark glow is able to pass through the transparent cover and be visible and that the user will not actually touch the glow in the dark surface. The disclosed golf grip can be formed through injection molding, extrusion, or thermoforming. In the preferred embodiment, a Horizontal injection molding machine is used to create the grip.

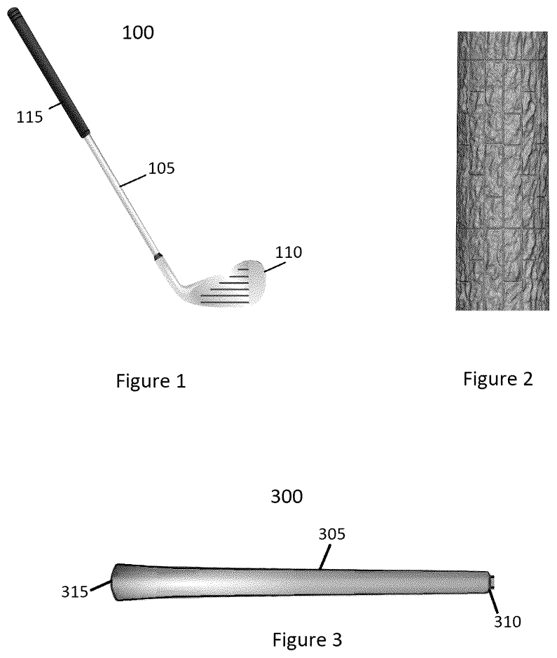

As depicted in FIG. 1, a golf club 100 comprises a club shaft 105 having an upper end and a lower end, a dub head 110 on a lower end of the shaft, and a grip 115 on an upper end of the shaft. At one end of the shaft is a golf club head, the golf club head connected to the shaft at an angle by a coupling or other similar means.

FIG. 2 depicts the golf club grip texture that allows for gripping of the golf club by a golfer. Use of the thermoplastic elastomer in the preferred embodiments allows for the production of the glow in the dark features while maintaining the necessary grip texture desired for use by a golfer.

FIG. 3 depicts a golf club grip 300 according to the teachings of this disclosure. The grip is formed to be a hollow tube 305. The shaft of a golf club is inserted into one end 310 of the tube which is sized to fit snuggly over the shaft of a golf club for installation. An adhesive on the inside of the tub shaped golf grip secures the grip to the club shaft. The golf club grip can further comprise an end cap closing the tube if the tube was not formed with one of the ends closed 315.

Golf club grips can be of a variety of colors having glow in the dark characteristics, offering several options for golfers using different phosphors to achieve the desired glow in the dark results. Such golf club grips store the light during the day and then radiate it at night. Alternative embodiments can use a combination of thermoplastic elastomers that have phosphorescent pigments incorporated therein and thermoplastic elastomers that do not. Designs can be created by configuring the materials during formation of the grip, that can be ornamental (stripes) or useful (alignment marks to help a golfer position his/her hands correctly), whereby part of the grip glows in the dark and part of the grip does not.

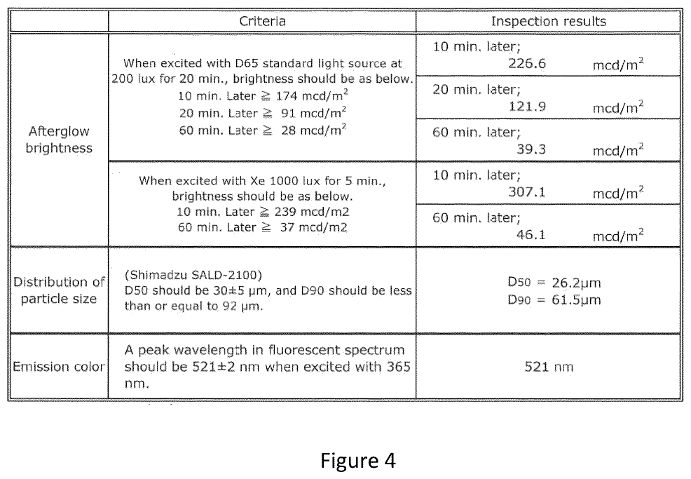

FIG. 4 is a chart of the phosphorescent pigment's characteristics and results of the preferred embodiment. As depicted, when the phosphorescent pigments are excited with a D65 standard light source at 200 lux for 20 minutes, brightness should be greater than or equal to 174 mcd/m² 10 minutes later, greater than or equal to 91 mcd/m² 20 minutes later, and greater than or equal to 28 mcd/m² 60 minutes later. When the phosphorescent pigments were excited with a D65 standard light source at 200 lux for 20 minutes, brightness was measured to be 226 mcd/m² 10 minutes later, 121.9 mcd/m² 20 minutes later, and 39.3 mcd/m² 60 minutes later. When the phosphorescent pigments are excited with a Xe 1000 lux 5 minutes, brightness should be greater than or equal to 239 mcd/m² 10 minutes later and greater than or equal to 37 mcd/m² 60 minutes later. When the phosphorescent pigments are excited with a Xe 1000 lux 5 minutes, brightness was measured to be 307.1 mcd/m² 10 minutes later and 46.1 mcd/m² 60 minutes later. Distribution of the particle size should be at D50 (50% of the total volume of material in the sample is contained) equal to 30±5 μm and should be at D90 (90% of the total volume of material in the sample is contained) less than or equal to 61.5 μm. Distribution of the particle size was found to be at D50 (50% of the total volume of material in the sample is contained) equal to 26.2 μm and D90 (90% of the total volume of material in the sample is contained) equal to 61.5 μm.

The preceding description contains embodiments of the invention, and no limitation of the scope is thereby intended. It will be further apparent to those skilled in the art that various modifications and variations can be made in the present invention without departing from the spirit or scope of the invention.

1. A golf club comprising:
a club shaft having an upper end and a lower end;
a club head on a lower end of the shaft;
a grip on an upper end of the shaft, wherein the grip material includes phosphorescent pigments having the property of luminescence.

2. The golf club of claim 1 wherein the grip has a textured surface.

3. The golf club of claim 1 wherein the grip further comprises alignment marks.

4. A golf club grip comprising:
a tube shape having an opening on one end, that a shaft of a golf club is inserted into;
wherein the grip material includes phosphorescent pigments having the property of luminescence.

5. The golf club grip of claim 4 wherein the grip has a textured surface.

6. The golf club grip of claim 4 further comprising an end cap closing the tube.

7. The golf club grip of claim 4 further comprising alignment marks.
